(19) United States
(12) Patent Application Publication
(10) Pub. No.: US 2021/0066931 A1
(43) Pub. Date: Mar. 4, 2021

(54) INTEGRAL ANTI-ARCING BATTERY CHARGER HOT DISCONNECT SYSTEM AND METHOD

(71) Applicant: Exide Technologies, Milton, GA (US)

(72) Inventors: James Randall Wade, Barboursville, VA (US); Garrett Andrew Moore, Charlottesville, VA (US)

(21) Appl. No.: 16/553,601

(22) Filed: Aug. 28, 2019

(51) Int. Cl. H02J 7/00

(52) U.S. Cl. CPC H02J 7/0031; H02J 7/0045

(57) ABSTRACT

A battery charger apparatus, system, method and computer product monitors changes and current and/or voltage to determine whether a hot disconnect event is occurring by monitoring changes in current and/or voltage over time and by providing a shutdown prior to arcing or early in the event based upon predetermined conditions representative of a hot disconnect, thus eliminating or significantly reducing the time and severity of the event.

### TECHNICAL FIELD

The present invention is generally related to battery chargers and more particularly to a system and method to provide integral anti-arcing disconnection for a battery charger.

### BACKGROUND OF THE INVENTION

In the material handling industry, industrial forklifts are parked in close location to battery chargers to facilitate plugging the battery of the forklift into the charger for charging. Standard practice is that when the charge is to be terminated, the operator presses a stop button on the charger. However, in practice, an operator or forklift driver will also unplug the battery connector without pressing the stop button when the battery is still under charge conditions. In this scenario, arcing will occur.

Arcing damages contacts and provides other potential hazards, depending on the environment. For example, if combustible gasses are present, combustion is possible.

One possible connection between the battery and a battery charger includes a signal auxiliary contact that breaks first to trigger the battery charger to immediately shut down before the power contacts break. This connection requires specialized intermediate hardware, including additional wiring/harnessing on the battery and on the battery charger. Such specialized hardware adds to the complexity and bulk of the overall system. These contacts also need maintenance intervals and periodic replacement.

What is needed in the art are anti-arcing solutions that avoid the above described and other problems and disadvantages in the art during hot disconnect.

### BRIEF SUMMARY OF THE INVENTION

According to an example embodiment of the present invention, a charger and charging system monitors changes and current and/or voltage to determine whether a hot disconnect event is occurring. The charger controller monitors changes in current and/or voltage over time and provides a shutdown prior to arcing or early in the event based upon predetermined conditions representative of a hot disconnect, thus eliminating or significantly reducing the time and severity of the event.

In exemplary embodiments, a “Over Voltage bar” value in the controller may be changed from a hard, fixed value to a commanded value from the controller to catch voltage step increases indicative of partial disconnect charging. Further, on-board firmware or software run by an on-board processor may detect the change in voltage over time (dv/dt) and/or change in current over time (di/dt) to detect a qualifying event for initiating shutdown. Further, such predetermined parameters may include values associated with dramatic changes in resistance.

In further exemplary embodiments, the controller or other on-board processor measures instantaneous changes in voltage and current to facilitate shutdown to eliminate arcing.

Additional features and advantages are realized through the system of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The figures:

FIG. 1 is a diagrammatic view of an exemplary anti-arcing battery charger and system in accordance with the present disclosure; and

FIG. 2 is an oscilloscope chart illustrating variation in voltage and current during hot disconnect and arcing;

FIG. 3A is a first portion of an exemplary block diagram of a comparator subsystem;

FIG. 3B is a second portion of an exemplary block diagram of a comparator sub system;

FIG. 4 is an exemplary diagram of current and voltage sensor locations in relation to a charger in accordance with the present disclosure;

FIG. 5 is an exemplary diagram of a comparator subsystem;

FIG. 6 is an exemplary architecture diagram for ePWN and Output X-Bars;

FIG. 7 is an exemplary architecture diagram for ePWM S-Bar;

FIG. 8 is an exemplary diagram of a Digital Compare Submodule of an exemplary ePWM module;

FIG. 9 is an exemplary diagram of an Event Triggering unit in accordance with embodiments of the present disclosure;

FIG. 10 is a diagram of an exemplary Trip-Zone Submodule of an exemplary ePWM module;

FIG. 11 is an exemplary ePWM block diagram; and

FIG. 12 is an exemplary flowchart logic diagram for coding requirements to implement partial disconnect detection.

### DETAILED DESCRIPTION OF THE INVENTION

Further to the brief description provided above and associated textual detail of each of the figures, the following description provides additional details of example embodiments of the present invention.

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments of the present invention will be described in detail. Example embodiments of the present invention provide an anti-arcing battery charger, system, method and computer product as described below.

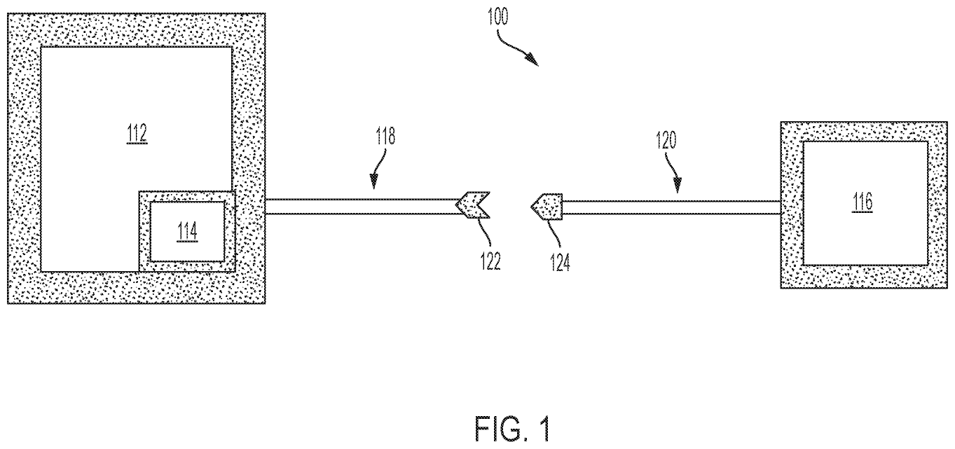

FIG. 1 illustrates an exemplary battery charger system, shown generally at 110, including a battery charger 112 having a control board 114, charging leads, shown generally at 118 and a charging connector 122. Exemplary battery 116 similarly includes charging leads, shown generally at 120 and a connector 124 that is complementary to connector 122. Such complementary connections may be male/female, may be genderless (e.g., APP SB350 connections keyed to interconnect correct polarity), or may comprise any other suitable connection. In exemplary embodiments, one or both of a current and voltage sensor is provided across the charging leads to measure instantaneous current or voltage at a point integral to the charger. Such point may be at the control board 114, at connector 122, or any point in between.

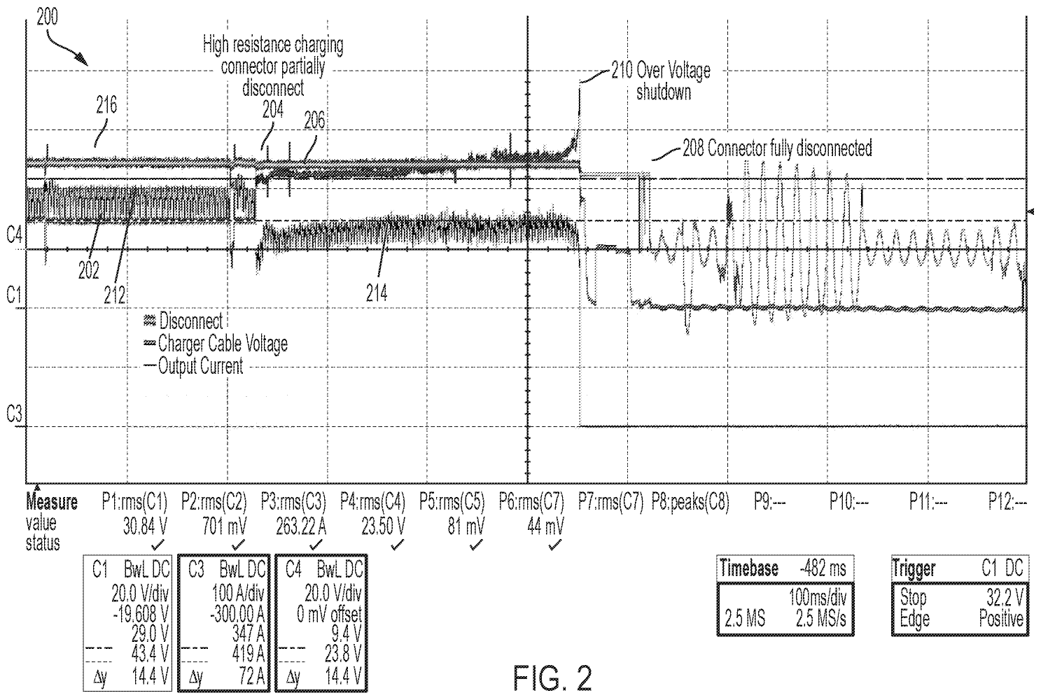

FIG. 2 shows an oscilloscope chart showing traces generally at 200 that describe changes in voltage and current during a hot disconnect of connectors 122 and 124 during charge. Initial parameters include a charger set for 380 amps (A), charging a 24 volt (V) battery. In the setup used for FIG. 2, handles were attached to either connector to facilitate a slow disconnection to better observe charger response.

Trace 202 is the charger cable voltage before partial disconnect 206 during high-resistance charging. Trace 212 is the output current before partial disconnect 214 during high-resistance charging. Trace 216 shows the disconnect signal prior to partial disconnect.

During the partial disconnect stage, starting at indicator 204, the voltage increases to 44V (see charger cable voltage trace at 206), while the current drops from 380 A to about 320 A (see output current trace at 214). This continues for about 300 milliseconds (ms). During the partial disconnect stage, visual and audible arcing is generally present.

The charger cable voltage continues to increase until, at 210, the charger shuts off at an approximate over-voltage of 72V (charger over Voltage shutdown and suppression). In the region before over-voltage, the charger appears to be regulating based on voltage. Full disconnect occurs about 100 ms after shutdown (see 208). Additionally, in exemplary embodiments, the charger voltage is set not to exceed 72V due to the charger over Voltage protection shut down.

Not to be bound by theory, the arcing represents a thermal welding condition during the partial disconnect due to heat losses (I²R, where I is the current and R is the resistance) of the contacts. A step voltage increase of about 15V from 29V to 44V and a current decrease from 380A to 320A is a product of increased resistance in partial disconnect. Given the above, wattage across contacts can roughly be calculated by taking the initial equivalent resistance under normal load and then the resistance under partial disconnect and taking the disconnect current squared times the difference of the resistance before and during partial disconnect. This is assuming no other resistances in the system have dramatically changed. Rnominal=29/380=0.0763Ω, Rdisconnect=44/320 =0.138, Current during partial disconnect=320 A, Wattage across connector during disconnect=(0.138−0.0763)*320²=6265 W. This high wattage across the small contact area of the connector generates the heat and therefore the welding event.

In normal operation, if the installation includes disconnect handles to provide a high force quick disconnect method less than 20 ms, the arcing can be reduced and damage is minimal in conjunction with high voltage suppression. However, due to the high force of disconnecting these high current connectors lends itself to the slower partial disconnect occurrences even with handles. In addition, it should be recognized that the severity of the change in resistance and arc welding is proportional to the current and time duration of disconnecting the connectors.

In exemplary embodiments, the present disclosure provides a charger and charging system that monitors changes and current and/or voltage to determine whether a hot disconnect event is occurring. The charger controller monitors changes in current and/or voltage over time and provides a shutdown prior to arcing or early in the event based upon predetermined conditions representative of a hot disconnect, thus eliminating or significantly reducing the time and severity of the event.

In exemplary embodiments, a “Over Voltage bar” value in the controller may be changed from a hard, fixed value to a commanded value from the controller to catch voltage step increases indicative of partial disconnect charging. Further, on-board firmware or software run by an on-board processor may detect the change in voltage over time (dv/dt) and/or change in current over time (di/dt) to detect a qualifying event for initiating shutdown. Further, such predetermined parameters may include detections of dramatic changes in resistance.

In further exemplary embodiments, the controller or other on-board processor measures instantaneous changes in voltage and current to facilitate shutdown to eliminate arcing.

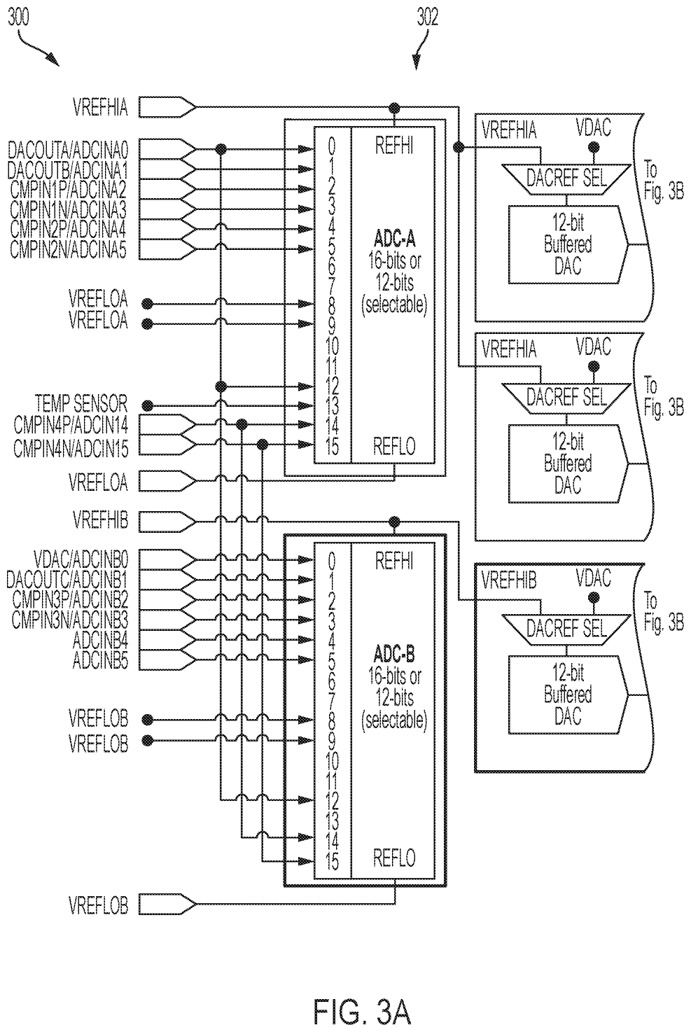

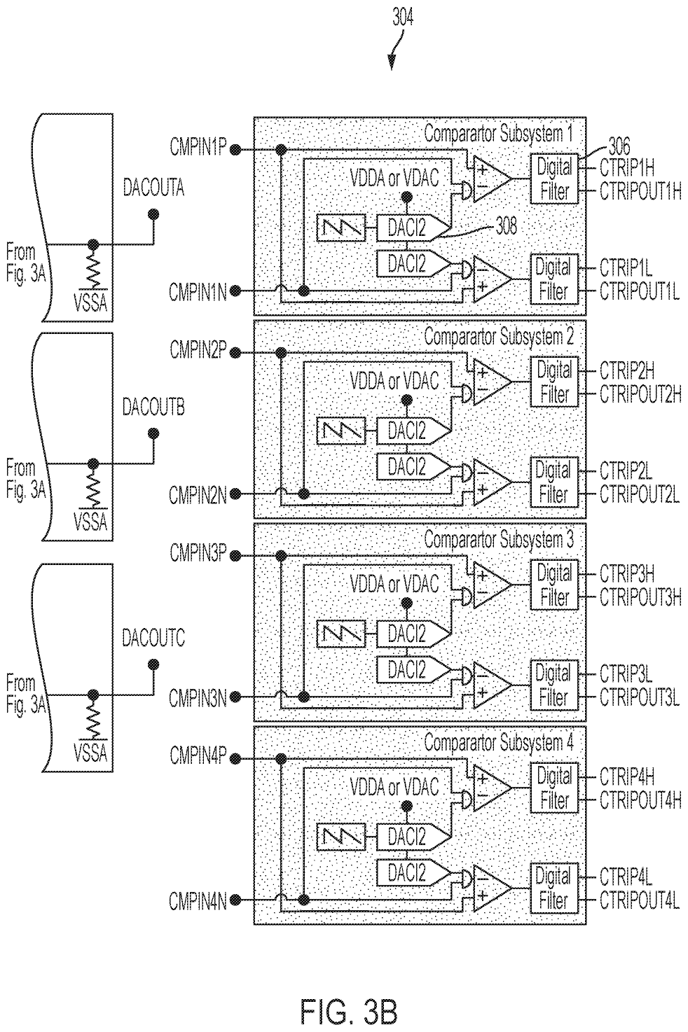

FIGS. 3A-B illustrate a block diagram for an exemplary configuration for signal routing in the TMS320F2837xS Analog Subsystem, illustrated generally at 300 and described immediately below. For the illustrated exemplary embodiment, the charger has an output current and voltage sensor located at the output of the charger.

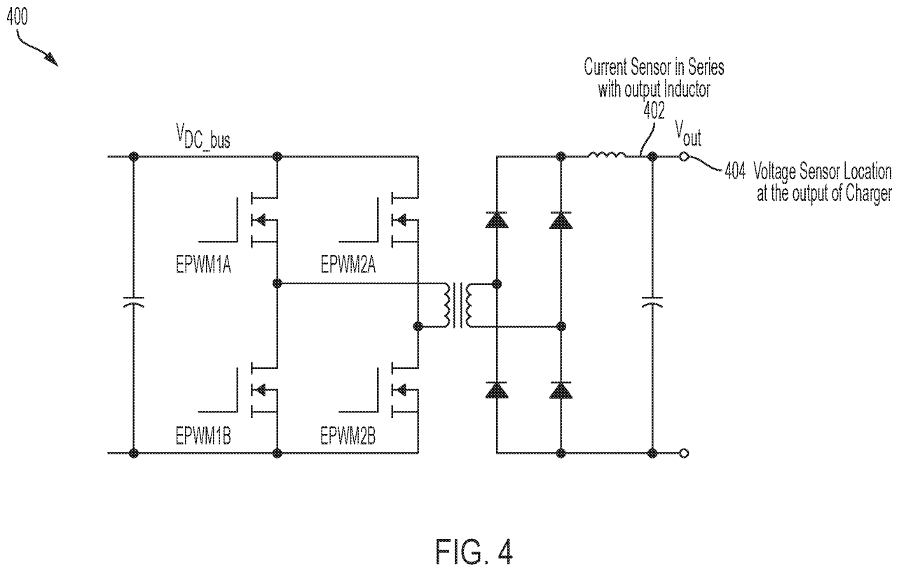

FIG. 4 illustrates an exemplary electrical diagram at 400, also showing at generally at 402 an exemplary current sensor in series with an output inductor and at 404 a voltage sensor location at the output of the charger.

Referring back to FIG. 3A, the sensors outputs are conditioned and scaled before feeding the ADC (analog to digital converter, shown generally at 302) of the processor (for example, a Delfino TMS320F28374S processor). The processor also has a CMPSS (comparator subsystem, shown generally at 304) tied to the ADC 302 inputs, wherein CMPINxP (x being, in FIG. 3A, a number between 1 and 4) is fed from the ADC input.

Referring still to exemplary embodiments represented by FIGS. 3A-B, voltage feedback is fed into the ADC 302 (CMPIN3P/ADCINB2) and routed to the CMPSS 3 comparator 304 positive inputs (labeled CMPINxP) for configuring of a dv/dt trip event. Note that any of the CMPINxP pins can be used and routed to the different CMPSSx modules.

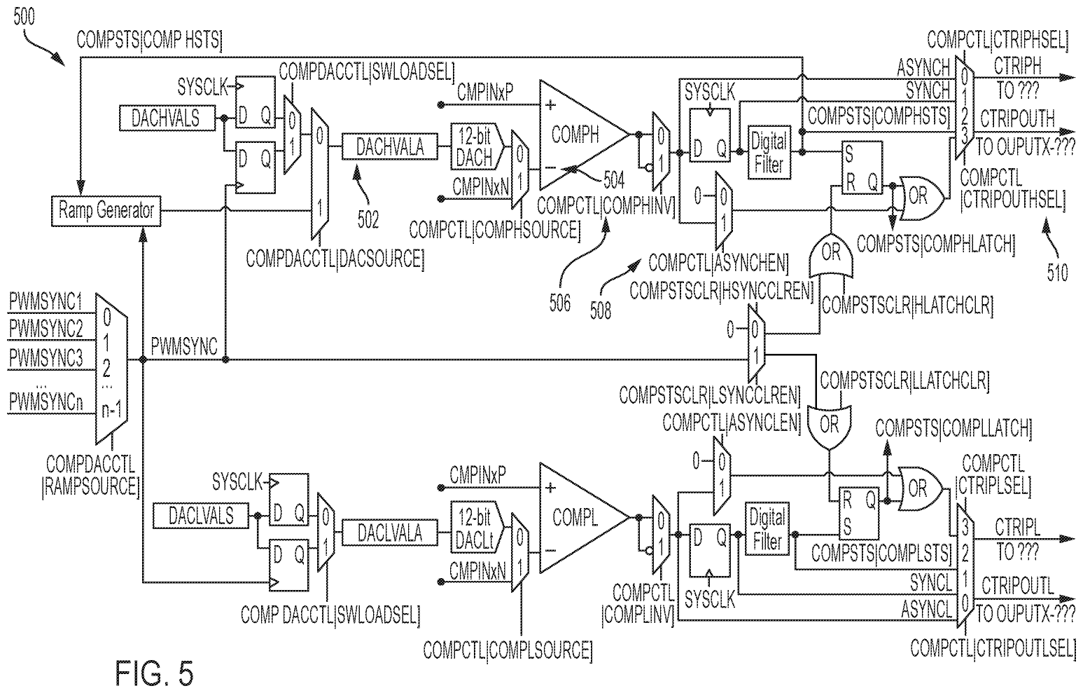

FIG. 5 generally shows an exemplary detailed block diagram of a CMPSS module at 500. The DACHVALA register 502 sets the 12 Bit DAC threshold value feeding the COMPH negative input (e.g., a 12 Bit DAC) 504 setting the threshold of dv/dt rise of output voltage that feeds the digital filter 306 (FIG. 3B) in the CMPSS.

Referring still to FIG. 5, in exemplary embodiments, before the digital filter 306 (FIG. 3) are other options for inverting and asynchronous operation. In exemplary aspects, the COMPCTL[COMPHINV] 506 is set to 0 so as not to invert the output of the comparator feeding the Digital filter. COMPCTL[ASYNCEN] 508 is set to 0 to disable synchronous operation. COMPCTL[CTRIPHSEL] 510 is set to 2 to select the Digital Filter output. Normal operation will have the comparator output low with the Voltage feedback CMPINxP being less than the DACH threshold. During a dv/dt event, the comparator will go high.

In an exemplary embodiment, the CMPSS DACH (308 in FIG. 3B) is set to represent output volts plus 5 volts feeding the negative comparator input. This sets the threshold of the output voltage increase due to the dv/dt event.

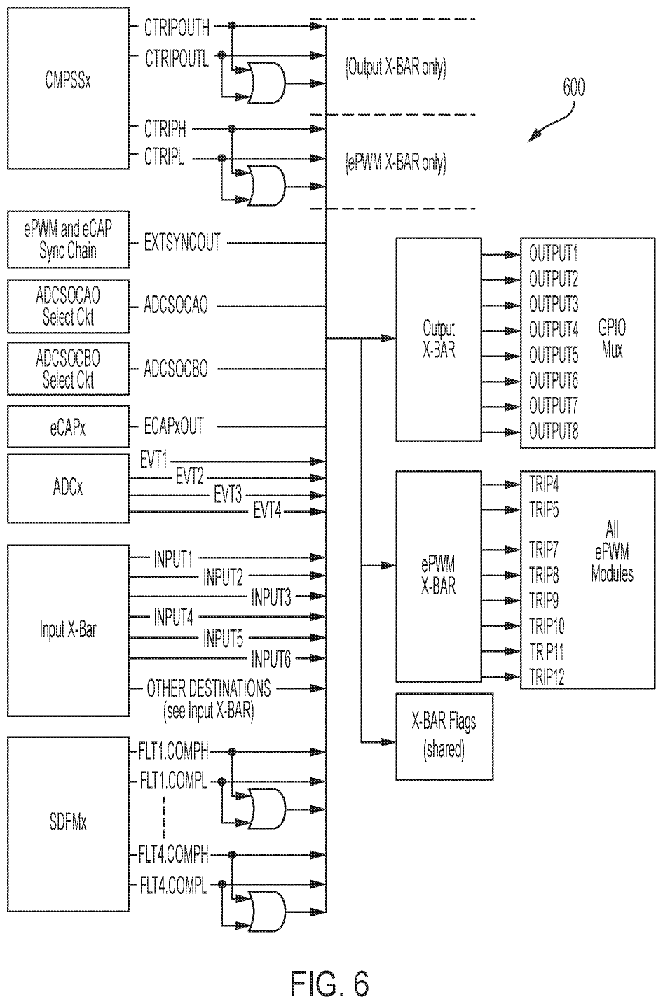

FIG. 6 shows generally at 600 an exemplary routing of CTRIPH to the ePWM X-BAR.

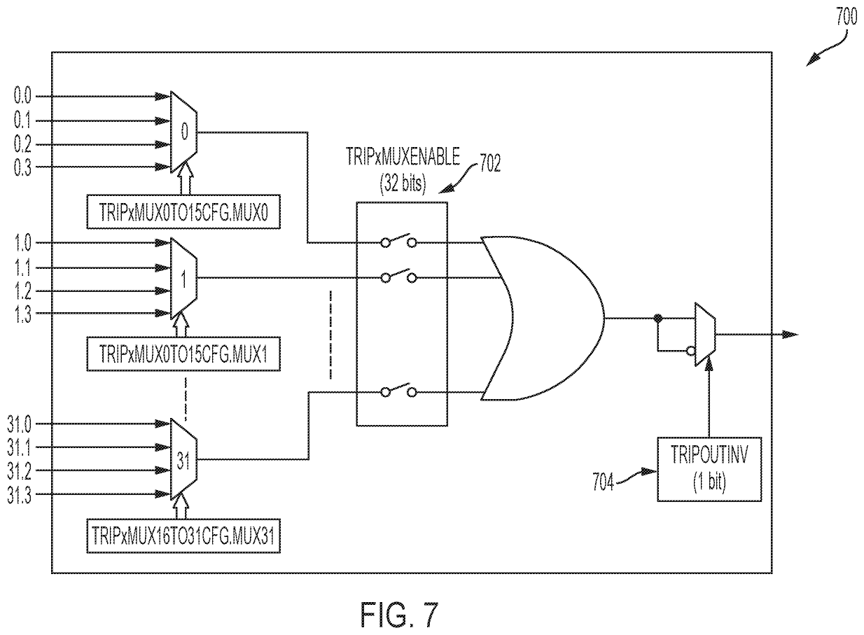

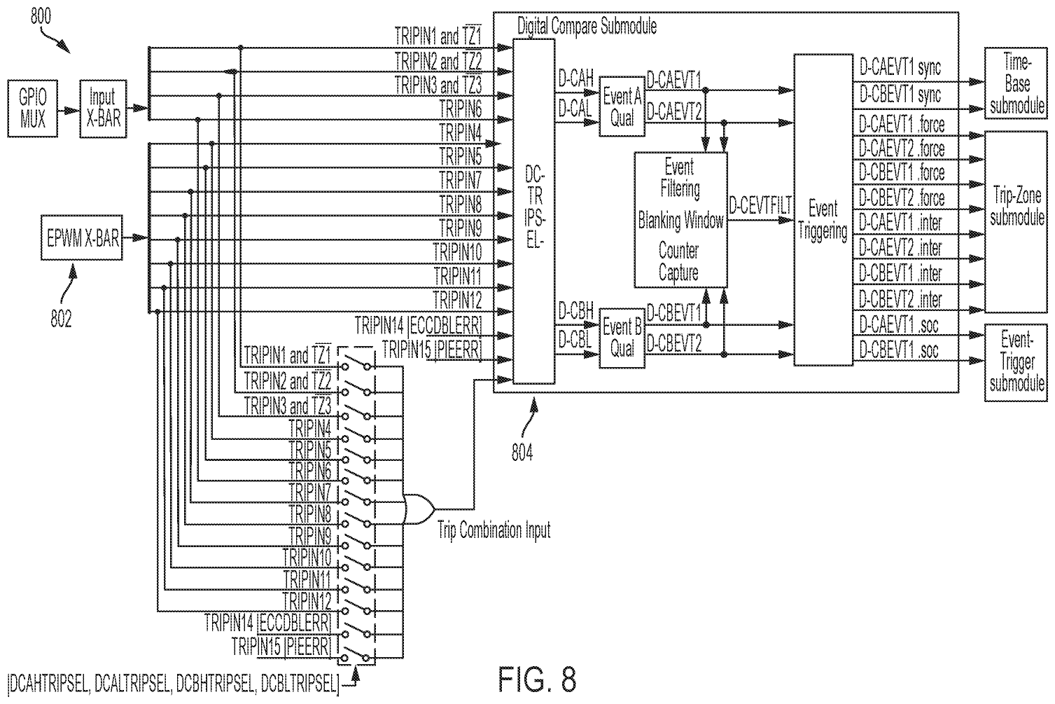

FIG. 7 shows generally at 700 the ePWM X-BAR for a single output. Trip mux configuration TRIPxMUXENBLE 702, and TRIPOUTINV 704 registers are set to route the CTRIPH signal through the ePWM X-Bar to the Digital Compare submodule (shown generally at 800 in FIG. 8) in the ePWM Module without inverting.

Digital Compare sub module 800 receives the routed CTRIPH from the ePWM X-BAR 802 on the selected TRIP4-TRIP12 depending on the ePWM mux configuration. For simplification, our application routed CTRIPH to TRIP7 via ePWM X-BAR. Referring still to

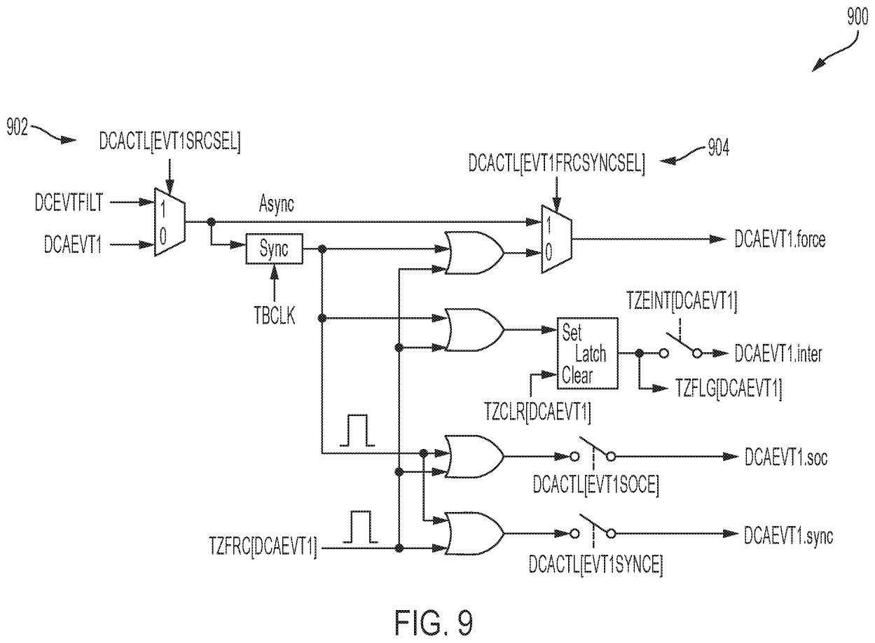

FIG. 8, DCTRIPSEL register 804 is set to select TRIP7 input for DCAH out to Event A Qual configured for DCAEVT1 to the Event Triggering unit. Event Filtering is disabled as the CMPSS module does the filtering. Event Triggering unit is set to generate DCAEVT1.force asynchronously by setting register DCACTL[EVT1SRCSEL] (902) to 0 and DCACTL[EVT1FRCSYNCSEL] (904) to 1 (see FIG. 9, which shows an exemplary event triggering unit generally at 900).

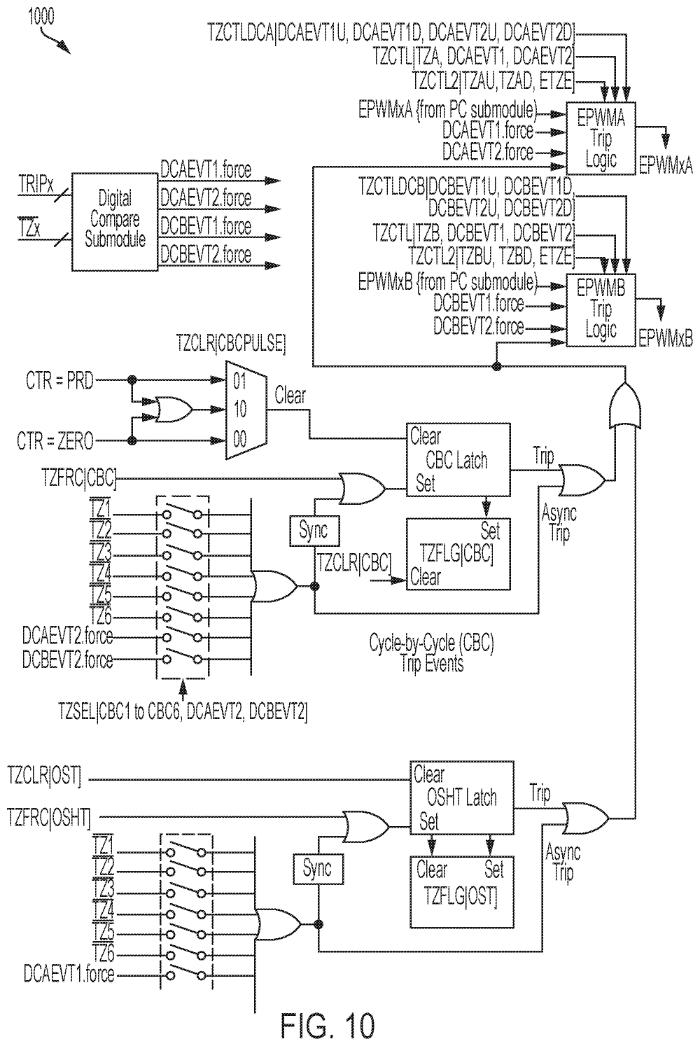

FIG. 10 illustrates generally at 1000 an exemplary Trip Zone submodule of the ePWM. TZSEL[DCAEVT1] is set to 1 and TZCTL[DCAEVT1] is set to 2 to allow the tripping and force the PWM signals low or off upon triggering event. In addition, TZEINT[OST] will be set to generate an interrupt when this dv/dt event occurs to allow shutting down the other ePWM module in the Bridge circuit. Alternatively, the CMPSS CTRIPH can be routed to other ePWM modules as previously described to have all used ePWMs shut down when this dv/dt event occurs.

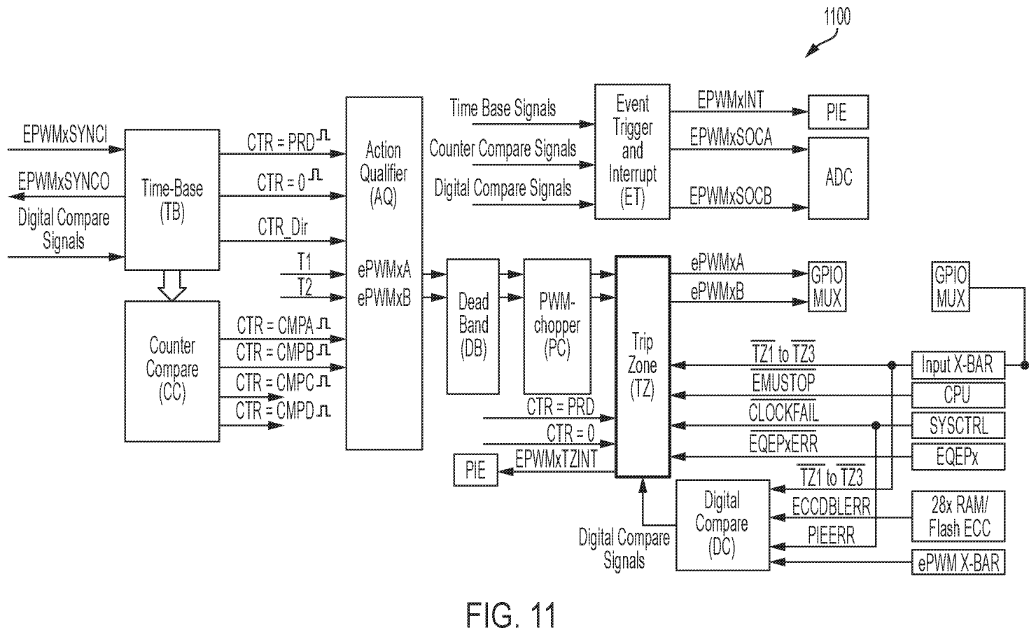

In exemplary embodiments, the digital filter sets sample rate, sample window size and number of majority hits to set CTRIPH in the CMPSS module initiating a trip condition and shutting the charger off via interrupt trip zone module within the exemplary ePWM module FIG. 11, shown generally at 1100, and as previously described.

Referring again to FIG. 3, in further exemplary embodiments, the digital filter 306 is set to sample at 500 ns and the sample window is 30 samples. The number of samples to cause the trip out is set to 27 (90%). Total sample window takes 15 us with a 90% hit rate to cause the trip. In short, an output voltage swing of more than 5V of the current regulated output for 15 us and a 90% failure rate will initiate the trip and shut the charger off for the dv/dt event caused by the connector disconnect event. This implementation only requires voltage feedback utilizing the DSP (digital signal processor), internal peripherals, and interrupts to facilitate the detection and shut down of the charger. As such, code for the implementation is only initialized at bootup. Software implementation only involves setting the trip threshold in the CMPSS and if a dv/dt event occurs, servicing the interrupt to clear, re-enable and log event error. Note that the CMPSS settings allow for flexibility to change the sample rate, sample window, and the threshold.

Implementation for di/dt is similar to the dv/dt using the analog subsystem and CMPSS of the DSP. The difference being setting the CMPSS DAC to represent 25 A lower than the regulated output current. As with voltage feedback, current feedback is fed to the CMPINxP input of the CMPSS comparator via ADC input. The CMPSS DAC is set for 25 A lower than output regulated current feeding the negative input to the comparator. The digital filter is set up with 500 ns sample rate, 30 samples, and 27 hits (90% of samples failed) to generate a trip output. If a di/dt is detected it will set CTRIPH shutting the charger off via an interrupt. The CMPSS (FIG. 5) will set COMPCTL[COMPHINV] to 1 to allow inverting the signal from the comparator. Unlike Voltage, the CMPINxP will be higher than the DACH threshold reference causing a nominally high output. Like voltage implementation, this only requires current feedback and code is mostly initialization with threshold and interrupt processing and error logging for code implementation.

The application has a choice to implement both di/dt and dv/dt trip methods or just one to detect the hot disconnect event and can be tuned for different applications and power levels.

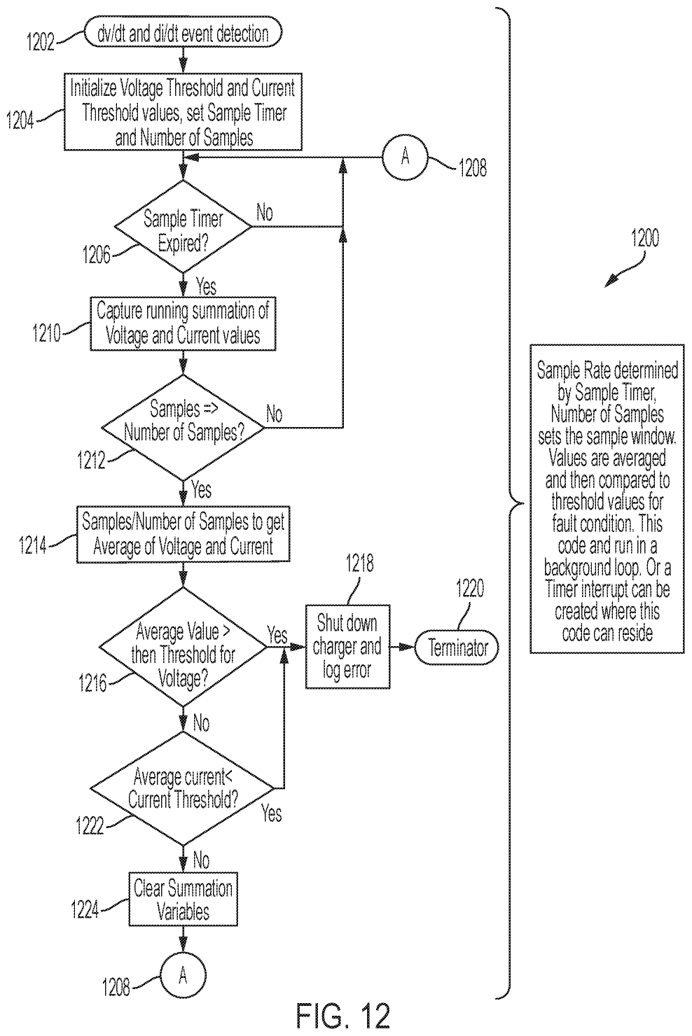

An alternative solution could be implemented with software utilizing the voltage and current feedbacks. FIG. 12 is a flowchart diagram demonstrating an exemplary background loop routine, illustrated generally at 1200, configured to capture the di/dt and or dv/dt disconnect events, a starting point of which is illustrated at 1202. The background loop implementation uses a sample timer to initiate the feedback sampling and collecting a running summation of current and voltage. The number of samples determine the sample window for the averaging of these values. The thresholds are then checked to determine if there has been a fault event. Depending on the code size and speed of the processor, the background loop may present limitations for the sample timer. For example, if the background loop takes 50 us, that would set the maximum sample timer rate. The sample timer could be accomplished with a timer interrupt to eliminate background loop timing to decreasing the sample rate time.

Referring still to FIG. 12, step 1204 indicates initialization of voltage threshold and current threshold values and setting of sample timer and number of samples. Step 1206 indicates a query as to whether a sample timer has expired. If “YES”, step 1208 indicates capture of an animation of voltage and current values. If “NO”, then flow reverts to prior to step 1206 at position “A” 1208, which represents a cycling flow subsequent to the initialization indicated in step 1204.

Following a “YES” event after step 1206, step 1210 performs a capture of a running of summation of voltage and current values. At step 1212, a determination of whether the desired number of samples has been achieved, with a “NO” determination routing the process to prior to step 1206. A “YES” determination results in step 1214, which indicates that the appropriate number of samples have been achieved to provide an acceptable average of voltage and current.

At step 1216, the system makes a determination as to whether the average value is equal to or exceeds the threshold for voltage. If “YES”, at step 1218, the charger is shut down and the error is logged. A terminator is shown at step 1220. If “NO”, at step 1222, a determination is made as to whether the average current is equal to or exceeds the current threshold. If “YES”, the charger is shut down, as at step 1218. If “NO”, summation variables are cleared at 1224, followed by reversion to “A”, step 1208.

The exemplary “A” to “A” loop bounded by items 1208 provide a sample rate that can be determined by a sample timer. Numbers of samples can set the sample window. Values can be averaged and then compared to threshold values for a fault condition. In further exemplary embodiments, code can run in a background loop, e.g., as shown. Additionally, a timer interrupt can hose such code.

In any of these implementations, voltage suppression should always be used to eliminate over voltage arcing due to cable inductance kick-back during disconnect. However, increasing the speed of detection of the partial disconnect will also reduce over voltage arcing.

As we have noted above, the present battery system presents an apparatus, system, method and computer software product that provides anti-arcing between battery chargers and batteries during hot disconnect. Exemplary embodiments describe arcing protection with integral detection, without the need for additional hardware, wiring or harnesses between the battery charger and the battery to reduce arcing, and without the additional maintenance such auxiliary systems require.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. An integral anti-arcing battery charger hot disconnect system, comprising:
a battery charger having a control board and charging leads and connectors;
at least one of a current and a voltage sensor integrated with said charger and configured to indicate instantaneous current or voltage, respectfully over said charging leads, the at least one sensor provided integral to the charger, with sensor measurement at a point between a control board and charger connectors;
a processor and nonvolatile memory configured to execute code, said code configured to define at least one of a current and a voltage threshold, measured by said one or more integrated sensors and triggering a charger shutdown.

2. The integral anti-arcing battery charger hot disconnect system described by claim 1, wherein said code averages sampled current and/or voltage values according to a defined sample rate to generate average current and/or voltage values that are compared to defined current and/or voltage thresholds.

3. The integral anti-arcing battery charger hot disconnect system described by claim 2, wherein shutdown of the charger results from determination that such thresholds are met or exceeded.

4. The integral anti-arcing battery charger hot disconnect system described by claim 1, wherein both current and voltage sensors are integral to said charger.

5. The integral anti-arcing battery charger hot disconnect system described by claim 4, wherein shutdown of the charger results from determination that either of current or voltage thresholds are met or exceeded.

6. The integral anti-arcing battery charger hot disconnect system described by claim 2, wherein shutdown of the charger does not result from determination that average current and/or voltage thresholds are met or exceeded, but instead summation variables are cleared followed by a software loop back to the beginning of sampling of running averages of current and/or voltage values.

7. The integral anti-arcing battery charger hot disconnect system described by claim 4, wherein shutdown of the charger does not result from determination that average current and voltage thresholds are met or exceeded, but instead summation variables are cleared followed by a software loop back to the beginning of sampling of running averages of current and voltage values.

8. A method for hot disconnection of an integral anti-arcing battery charger, comprising:
providing a battery charger having a control board and charging leads and connectors;
with at least one of a current and a voltage sensor integrated with said charger, measuring instantaneous current or voltage, respectfully over said charging leads, the at least one sensor provided integral to the charger, with sensor measurement at a point between a control board and charger connectors;
with a processor and nonvolatile memory configured to execute code, executing said code to define at least one of a current and a voltage threshold, measured by said one or more integrated sensors and triggering a charger shutdown.

9. A method for hot disconnection of an integral anti-arcing battery charger described by claim 8, wherein said code averages sampled current and/or voltage values according to a defined sample rate to generate average current and/or voltage values that are compared to defined current and/or voltage thresholds.

10. A method for hot disconnection of an integral anti-arcing battery charger described by claim 9, wherein shutdown of the charger results from determination that such thresholds are met or exceeded.

11. A method for hot disconnection of an integral anti-arcing battery charger described by claim 8, wherein both current and voltage sensors are integral to said charger.

12. A method for hot disconnection of an integral anti-arcing battery charger described by claim 11, wherein shutdown of the charger results from determination that either of current or voltage thresholds are met or exceeded.

13. A method for hot disconnection of an integral anti-arcing battery charger described by claim 9, wherein shutdown of the charger does not result from determination that average current and/or voltage thresholds are met or exceeded, but instead summation variables are cleared followed by a software loop back to the beginning of sampling of running averages of current and/or voltage values.

14. A method for hot disconnection of an integral anti-arcing battery charger described by claim 11, wherein shutdown of the charger does not result from determination that average current and voltage thresholds are met or exceeded, but instead summation variables are cleared followed by a software loop back to the beginning of sampling of running averages of current and voltage values.
